(19) United States
(12) Patent Application Publication
(10) Pub. No.: US 2026/0194603 A1
(43) Pub. Date: Jul. 9, 2026

(54) SYSTEM AND METHODS OF ELECTROMAGNETIC AUGMENTATION OF SYNTHETIC OBJECT COMPOSITION

(71) Applicants: Nicole Reineke, Northborough, MA (US); Alexander Reineke, Northborough, MA (US)

(72) Inventors: Nicole Reineke, Northborough, MA (US); Alexander Reineke, Northborough, MA (US)

(21) Appl. No.: 19/264,181

(22) Filed: Jul. 9, 2025

Related U.S. Application Data
(60) Provisional application No. 63/742,497, filed on Jan. 7, 2025.

(51) Int. Cl. G01R 33/00; G06F 21/31

(52) U.S. Cl. CPC G01R 33/0023; G06F 21/31

(57) ABSTRACT

Synthetic object generation with electromagnetic augmentation is disclosed. Objects, including living objects, may be replicated as synthesized objects. The synthesized objects are configured using metadata and are configured to emit electromagnetic signatures to deepen a realism of the synthesized object, enhance connections and relationships.

### TECHNOLOGICAL FIELD OF THE DISCLOSURE

Embodiments disclosed herein generally relate to electromagnetic signatures and to synthesizing electromagnetic signatures. More particularly, at least some embodiments relate to systems, hardware, software, computer-readable media, and methods for synthesizing characteristics, including electromagnetic signatures, of objects including living objects.

### BACKGROUND

Electromagnetic (EM) radiation permeates space and may come from a variety of sources. Example sources of EM radiation include, by way of example only, radio transmitters, light bulbs, and the human body. EM radiation may also exist at a variety of frequencies or types such as, by way of example, radio, microwave, infrared, visible, ultraviolet, and X-rays.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a synthetic object configured to emit EM radiation operating in an environment;

FIG. 2 discloses aspects of a system for capturing, synthesizing, and replicating EM signatures;

FIG. 3 discloses aspects of methods for capturing, synthesizing, and/or replicating EM signatures; and

FIG. 4 discloses aspects of a computing device, a computing system, or a computing entity.

### DETAILED DESCRIPTION OF SOME EXAMPLE EMBODIMENTS

Embodiments disclosed herein generally relate to augmenting synthetic objects with electromagnetic (EM) signatures (e.g., EM fields/waves/radiation). More particularly, at least some embodiments relate to systems, hardware, software, computer-readable media, and methods for synthesizing EM signatures in synthesized objects.

AI (Artificial Intelligence) or generative AI (GenAI) is often used in the context of computer-generated simulations and synthetic objects. This allows many characteristics of animate beings, such as, by way of example only, voice, voice tone, word choice, speaking patterns, sentiment, and/or visual appearance to be simulated. Thus, a synthetic representation of a person, animal, or plant simulates attributes of the person, animal, or plant. Embodiments of the invention relate to simulating the electromagnetic signatures emitted by animate or living beings. Embodiments of the invention are discussed in the context of simulation, but may also be applied to emulation.

EM signatures, by way of example only, refers to EM fields and/or EM radiation and are aspects of how living organisms interact with their environment. Embodiments of the invention relate to replicating/simulating the EM signatures of living organisms in synthetic objects. This enables synthetic object to better mimic or simulate the presence of living organisms and better create an immersive or realistic experience.

To achieve an improved sensory experience, simulating detectable stimuli, such as EM signatures, is beneficial. Embodiments of the invention may be implemented a variety of applications including, but not limited to, simulating human-plant interactions, creating more lifelike robotic pets or humanoid companions, improving emotional depth in remote communication, and the like. Embodiments of the invention thus relate, by way of example only, to replicating or simulating EM signatures in applications, synthesized objects, and/or environments.

As demonstrated in plant-based research studies, animate objects and beings detect, respond, and/or react to electromagnetic signatures. Embodiments of the invention relate to synthetic objects (e.g., AI driven or software driven objects, whether virtual or physical) that are able to simulate or generate EM signatures. Adding EM signatures to synthetic objects may deepen the realism of the synthetic objects, improve remote communications in personal and professional contexts, and the like. Embodiments of the invention further relate to synthetic objects that may be configured to emit EM signatures that are configured to an existing context or that can dynamically adapt to changing contexts. For example, a pet robot may be configured to emit EM signatures and dynamically adapt the EM signatures being emitted in a manner that depends on a perceived mood or emotion (e.g., a sentiment) of a user, on environmental factors, or the like.

More generally, embodiments of the invention integrate EM signatures with software and/or hardware-based synthesized objects to replicate characteristics of living beings or other objects including their EM signatures. EM signatures are an integral part of interactions between living organisms and their environment, which may include other living organisms (e.g., human-plant interactions). Embodiments of the invention capture, store, and replicate EM signatures synthetically in one example.

Generally, embodiments of the invention relate to an synthesis engine (also referred to as an EM engine) that may have access to or receive a variety of different data and other inputs. The synthesis engine may be configured to generate a synthesized object that may include aspects of multiple distinct objects, which may be represented by metadata.

One aspect of the data used by the synthesis engine relates to EM signatures. Embodiments generate a database of EM signatures that may be collected from different sources and/or different contexts or scenarios. As previously stated, EM signatures refer, by way of example, to electromagnetic radiation/fields that may emanate from an object, an entity (e.g., a person or other animate object), or that may be present in an environment.

Embodiments of the invention may collect and store EM signatures from a variety of sources using a variety of collection systems. Example systems that may be used to capture EM signatures on a variety of objects may include, but are not limited to:
Magnetometers: Measures magnetic fields, often used in geomagnetic studies or for detecting low-frequency EM fields;
Electroencephalography (EEG) Machines: Records the electrical activity of the brain, indirectly measuring EM fields generated by neuronal activity;
Electrocardiography (ECG) Machines: Detects the electrical signals of the heart, producing data on its EM activity;
SQUID (Superconducting Quantum Interference Device): Extremely sensitive magnetometer used to measure subtle magnetic fields, including those emitted by biological systems;
Multimeters with EMF Detection: Measures electromagnetic field strength and voltage in electronic devices and environments;
EMF Meters (Gaussmeters): Specifically designed to measure the strength of electromagnetic fields in a given environment, commonly used for safety assessments;
MRI (Magnetic Resonance Imaging) Scanners: Uses strong magnetic fields and radio waves to capture detailed images of the body, often detecting EM field variations in tissues;
Electric Field Probes: Measures the strength and direction of electric fields in a specific area, often used in laboratory settings;
Thermal Imaging Cameras with EM Sensitivity: Some advanced models can detect infrared EM radiation, providing insights into heat-related EM signatures;
Electromagnetic Spectrum Analyzers: tools for analyzing a wide range of electromagnetic waves, from radio frequencies to light waves, often used in scientific and industrial research;
Inductor: A passive electronic device used to store electric energy as magnetic energy;
Electromagnets: An electronic device that uses electricity to create a magnetic field; and/or
Advanced haptic systems: Full-body suits or vibrotactile interfaces that attempt to mimic the sensation of being surrounded by physical energy.

Electromagnetic signatures collected by these systems are stored such that they can be reproduced physically using, by way of example only, electrodes, antennas, heat sources, infrared emitters, blackbody simulators, or the like. These sources are referred to herein as emitters.

In addition to collecting the electromagnetic signatures, the electromagnetic signatures may be associated with context. For example, when collecting an electromagnetic signature of a person, the person may be asked questions such as how they feel, whether they are healthy, or the like. Other context information such as environmental context (e.g., weather, time, location, indoor/outdoor) may be collected and associated with the electromagnetic signatures. This type of context allows the electromagnetic signatures to be searchable based on context and generated by a synthetic object accordingly. In another example, an electromagnetic signature may be generated in an effort to bring about a change in a user. For example, a synthetic object may be configured to emit an EM signature consistent with happiness in an attempt to cheer up a user perceived as sad.

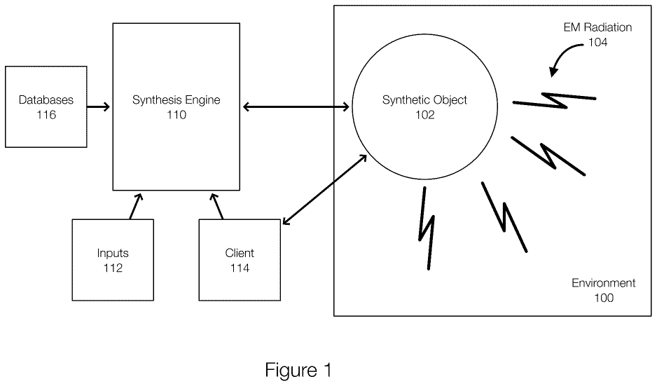

FIG. 1 discloses aspects of an EM simulation system including a synthetic object, configured to emit an EM signature, operating in an environment. FIG. 1 illustrates an environment 100 and a synthetic object 102 deployed in or operating in the environment 100. The synthetic object 102 may be configured to emit EM radiation 104, which is an example of an EM signature. For example, the synthetic object 102 may include or be coupled to an emitter.

Generally, the synthetic object 102 may be virtual, physical, software generated, or the like. For example, the synthetic object 102 may be illustrated as an avatar on a computer display that may be coupled with an emitter such that the EM radiation 104 may be “emitted” by the synthetic object 102. The synthetic object 102 may be a hologram, a physical device, or the like. The synthetic object 102 may include multiple distinct physical and/or virtual components that may each emit the same or different EM signatures.

The characteristics (e.g., frequency, wavelength) of the EM radiation 104 emitted by the synthetic object 102 may depend on an application and/or what the synthetic object 102 represents or simulates. The characteristics of the EM radiation 104 may also depend on a temperature and/or shape of the synthetic object being simulated. For example, if the synthetic object 102 is configured to simulate a person, the EM radiation 104 is configured to mimic the EM radiation associated with a person, which may account for a person's average body temperature, surface area, and/or emissivity.

Generally, the EM radiation associated with a person is infrared or thermal radiation related to body heat. Thus, the EM radiation may have be in a range of 3 to 20 micrometers. A person may also emit other types of radiation, including radio frequency emissions, but this may be very weak.

If simulating a person, the synthetic object 102 (or its associated emitter or emitters) may be configured to emit infrared radiation in a range of 3 to 20 micrometers. In one example, the synthetic object 102 may include or be associated with an emitter that includes heating elements that may be set to simulate human temperatures, thereby emitting EM radiation similar to the EM radiation radiated by a person. In one example, the synthetic object 102 may include or be associated with a blackbody emitter configured to emit EM radiation that is dependent on temperature. Depending on application, the synthetic object 102 can be configured to emit a desired EM radiation. The synthetic object 102 may also adapt such that the EM signature changes for various reasons, such as changes in the environment, changes in a user, based on a schedule, or the like.

The synthetic object 102 may also be configured to have a shape similar to the entity being simulated. For example, if emulating a person, the object 102 may be a mannequin or have curved surfaces to somewhat resemble a human shape or portion thereof. In another example, embodiments of the invention are more focused on simulating the EM signature rather than the shape of a person. This may allow the synthetic object 102 to be more compact if physical in nature. Further, as previously stated, the synthetic object 102 may be displayed on a display or have another virtual representation.

In one example, multiple synthetic objects 102 may be deployed in an environment. Each of the synthetic objects may be configured to emit the same or different EM signatures.

The ability to emit an EM signature that may correspond to a human may be based on a collection of EM data collected from one or more persons and stored in a database.

For example, the EM signature generated by a person may be collected over time and correlated to the person's health, emotions, environmental conditions (e.g., weather, temperature, location), and the like. This allows EM signatures to be correlated to emotion or mood and other factors. This may allow a database of EM signatures to be constructed and stored in databases 116. As a result, the synthesis engine 110 can set and/or dynamically adapt the EM radiation 104 emitted by the synthetic object 102 based on data collected and stored in the databases 116. The selection of an EM signature from the databases 116 may also depend on factors of the environment 100, users in the environment 100, or the like. For example, if the environment 100 is a greenhouse, turning on an irrigation system may be detected and cause the emission of the EM radiation 104 by the synthetic object 102.

In one example, a client 114 may interact with the synthetic object 102 directly or via the synthesis engine 110. The client 114, for example, may input instructions or characteristics into the synthesis engine 110 via a user interface. The input is used to draw data or information from the databases 116 to construct the synthetic object 102. Thus, in one example, the synthesis engine 110 may receive inputs 112 that may influence how the synthetic object 102 is configured, speaks, looks, emits EM radiation, and the like.

For example, the inputs 112 may include sound levels, temperature, location, event information, user sentiment data, role data, capability data, or the like. This information may be used to select the EM radiation 104 emitted by the synthetic object 102. As the inputs 112 change, the EM radiation 104 may also change. The client 114, in some examples, can also select or direct specific EM radiation 104 configurations.

The synthetic object 102 may have a variety of different configurations. The synthetic object 102 may be configured to communicate (e.g., using networking hardware, a display) with the synthesis engine 110 and/or the client 114. This may occur in a wired or wireless manner. This may occur when the synthetic object 102 is docked (e.g., for recharging a physical object). The synthetic object 102 may have a processor or controller configured to cause an emitter (e.g., heater, antenna, electrode) to emit a desired EM radiation 104. When implemented in a computer, the synthetic object 102 may be a module that communicates with the synthesis engine 110 for configuration data and may be able to control an emitter.

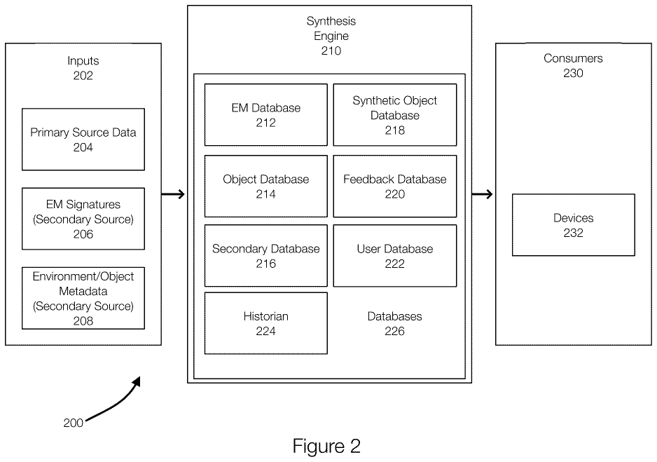

FIG. 2 discloses additional aspects of an EM simulation system. The EM simulation system 200 includes an synthesis engine 210 (engine 210) configured to receive inputs 202 and interact with consumers 230, such as devices 232, which may include synthetic objects. The synthesis engine 210 may include processors, memory, and other suitable hardware and may be implemented in an edge-system, a cloud-system, an on-premise system, in a client-server system, in a distributed system, or the like or combinations thereof.

In this example, the devices 232 may represent or include objects or synthesized objects configured to emit EM signatures (EM radiation, waves, or fields). The EM signatures emitted by the devices 232 may be identified or provided by the synthesis engine 210 using various databases and/or the inputs 202.

The inputs 100 include data or information that may be used to build some of the databases 116 used by the synthesis engine 210. For example, the primary source data 204 may include input or information from a participant (e.g., an animate organism) and/or an environment. The primary source data 204 may include metadata such as date of birth, mood, sex, body temperature, voice recordings, words, or the like. Some of this source data 204 may be collected via a survey or the like.

The EM signatures 206 is an example of a secondary source and may include EM signatures. In one example, the primary source data 204 and the EM signature 206 are collected contemporaneously and may be correlated or related in the synthesis engine 210. The EM signatures 206 may represent EM radiation collected using collection systems discussed previously.

The environment/object metadata 208 is another example of a secondary source and may include data such as sound levels, temperature, location, description, event information, inferred score (e.g., sentiment scores using artificial intelligence analysis), and the like. The metadata 208 can be correlated or associated with the EM signatures 206 and/or the primary source data 204 where appropriate.

As the inputs 202 are collected and stored, they represent or correspond to EM signatures in a variety of circumstances. Thus, the EM signature of a user may be associated with metadata reflecting the scenario such as an emotion of the user (happy with plant growth), location of the user (in a greenhouse), temperature (ambient greenhouse temperature), location (inside, geographical location), age of user, and the like.

This allows the synthesis engine 210 to dynamically generate or instruct EM signatures based on a current context. For example, if a synthetic object is generated as a companion to a user and the user is feeling sad (e.g., based on a detected sentiment), the synthetic object can be configured to emit an EM signature consistent with a happy feeling. Thus, the synthetic object can be responsive to external stimuli.

Thus, the inputs 202 represent data that may be collected and stored in the synthesis engine 210. The inputs 202 may also represent a current context that allows a synthetic object to be synthesized or generated by the synthesis engine 210 taking into account a current context. Thus, a current context may be used to select data in the databases 226 used to generate or construct a synthesized object or to produce data that can be consumed by one of the consumers 230.

In this example, the synthesis engine 210 may have access to a variety of databases 226 (an example of the databases 116). The engine 210 can process, store, and synthesize EM inputs into actionable outputs.

The databases 226 are described by way of example and not limitation and may include a data store (a non-transient computer readable medium).

The EM database 212, by way of example, may include or store electromagnetic data collected from secondary sources (e.g., magnetometers, SQUID devices). In one example, the EM database 212 may include entries structured as follows:
Source: This identifies an origin of the data (e.g., device identifier and location);
Date/Time: A timestamp of when the data was collected;
Values: an array of raw EM field values; and
Primary Source Key: Links data to associated primary source records for contextual association.

The object database 214 may store a record of objects or entities that generate EM signatures and their metadata. In one example, the object database 214 may include entries structured as follows:
Primary Source: An identifier of the object (or entity) producing EM signatures;
Object Type: Specifies a type of the object (e.g. biological, electronic, environmental);
EMF: An array of EM data tied to the object;
Metadata: Metadata describing attributes of the object.

The secondary database 216 may be configured to store secondary sources of data and their relationships to primary sources. In one example, the secondary database 216 may include entries structured as follows::
Secondary Source: An identifier for the secondary data source (e.g., environmental sensor, sentiment AI);
Primary Source Key: Links back to a relevant primary source;
Location: Geographic or spatial location where the data was collected.

The synthetic object database 218 is configured to store synthesized representations of objects based on EM signatures and metadata inputs. In one example, the synthetic object database 218 may include entries structured as follows:
Synthetic (Boolean): Indicates if the object is synthesized;
EM Key: Links to EM signature data from the EM datastore 212;
Secondary Key: Links to secondary metadata for context in the secondary database 216

The feedback database 220 is used to capture user or system feedback such that synthetic object generation can be refined. In one example, the feedback database 220 may include entries structured as follows:
Unique Id: Identifier for the Feedback Entry;
Primary Source Key: Links Back to Primary Data Sources:
Location: A spatial context of the feedback.

The user database 222 may be configured to manage user information, permissions, and associated metadata. In one example, the user database 222 may include entries structured as follows:
User Name: Unique User Identifier;
Permissions: Defines access rights and roles;
Metadata: User-related attributes.

The historian 224 is configured to archive data and relationships for analysis and traceability. In one example, the historian 224 may include entries structured as follows:
Unique ID: An identifier for each historical record;
User Name Key: Links to the user that generated or interacted with the data;
Object Key: Links to the associated object or entity;
Array: An array of historical instances or actions for analysis.

The consumers 230 are typically configured to consume data processed or generated by the synthesis engine 210. The consumers 230 may include devices 232. The devices 232 represents external systems, software, and/or hardware that consume data from the synthesis engine 210. Synthetic objects may be examples of the devices 232. For example, virtual reality headsets, augmented reality devices, smart devices capable of displaying or simulating EM environments, wearable technology that reproduces synthesized EM signatures for user interaction, stand-alone devices configured to reproduces EM signatures in an environment, and the like or combinations thereof.

The system 200 represents a framework or pipeline for collecting, processing, synthesizing, and/or deploying EM data in environments, including synthetic environments. Embodiments of the invention allow EM signatures to be integrated into practical applications.

In one example, a synthetic object may be defined as a set of metadata, attributes and outcomes.

For example, a synthetic object may be defined to represent a gardener. The gardener may be defined to have voice data from a first object, a visual representation from a different object, and an EM field of a yet another object. When the synthetic gardener is invoked, turned on, or otherwise accessed (e.g., via software) and generated, these attributes are pulled from the databases (e.g., databases 116 or 226) and used for behaviors, interactions, and responses.

The synthesis engine 210 can generate and deploy a synthesized object having various characteristics and able to emit an EM signature (e.g., using an associated emitter).

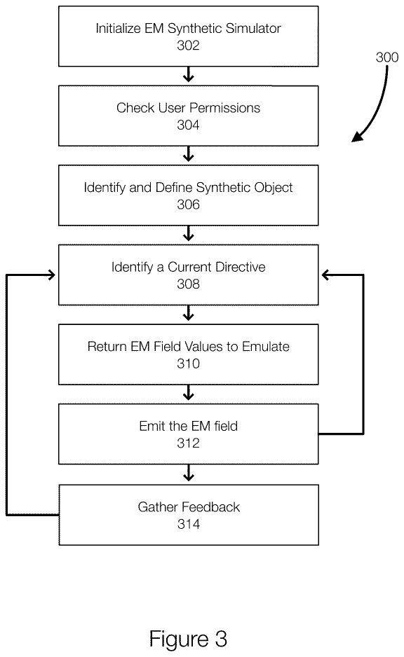

FIG. 3 discloses aspects of a method for generating a synthetic object. The method 300 includes activating an synthetic simulator 302. Activating, accessing, or turning on the synthetic simulator (e.g., an synthesis engine 210) is an example of or may invoke an initialization operation that enables the synthetic simulator to begin processing inputs and managing a synthetic EM environment. The initialization ensures that all components (e.g., databases, sensors) are connected and operations. A synthetic system may be simple and compact (e.g., a smartphone) or other device capable of producing electrical impulses and running operations or more complex such as a set of devices including satellite links, external devices, and internal devise that work together to produce or achieve an objective. For example, may synthetic objects can be used to produce or simulate a crowd.

Once the system is initialized, user permissions are checked 304. This ensures that the system and user access data and synthesized objects for which permission is had. User authorization helps comply with privacy and ethical standards

Next, the object being synthesized is identified or defined 306. This may include receiving input from a user related to the object or entity for which a synthetic EM field will be generated. The input may include settings selected in a user interface. For example, the user may select a directive to increase crop production my simulating exposure to their worker (e.g., the synthesized object) twice a day at watering time.

More specifically, an object may be a collection of variables. An object may be a concept that can contain zero or more sets of associated primary and secondary metadata. Object may range, by way of example, from physical devices to plants to human participants or environmental features. When identifying the synthetic object, metadata may be retrieved to identify the object type and relevant attributes. For example, in case of a synthetic persons, the synthetic object may include metadata such as:
Voice recording (as collected directly through electronic or other methods or as rendered through generative AI or other replay device),
Video recording (as collected directly through electronic or other methods or as rendered through generative AI or other replay device),
Gender and age 10-year old,
Location 10 Roadway Ave, Newark, New Jersey
Positive caretake John Smith,
Torturer: crow,
Electromagnetic field variables
   Action: Emotional State;
   During exposure to specific music vs John Smith present vs crow present: electromagnetic field: time.

Metadata can be mixed and matched to create new objects that have not previously existed. For example: the voice of Oprah would be matched with the video of a tree to generate a talking tree using generative AI and pair the talking tree with the electromagnetic field of the Dhali Llama in an attempt to create a synthetic object that exemplifies one vision of a calming being.

More generally, synthetic objects are synthesized from objects stored in the databases. This allows the synthesized object to take on a variety of characteristics, which are changeable. A user, for example, can change the voice or the appearance. The user may also change the EM signatures. The metadata associated with the objects using to generate a synthesized object may provide data that allows the synthesized object to be built. EM data or metadata, for example, may specify characteristics of the EM signature (e.g., frequency, amplitude, temporal characteristics (repetition, modulation waveform, transients), and the like that allow a specific EM signature to be emitted. Similarly, other metadata may be used to define other characteristics, actions, functions, and the like of the synthesized object.

In addition, the synthesized objects can be quickly adapted. For example, changing the EM signature may simply require providing different EM metadata. Further, the databases may be searchable such that EM data associated with various emotions, environments, or other factors can be identified and used. This may allow a user so specify an EM signature for a small room with a certain ambient temperature with no light. Many different synthesized objects can be generated by mixing and matching.

The method 300 may also identify 308 a current directive. The determines the task or objective for the current synthetic object. More specifically, a directive may include specific instructions such as replicating a real-world electromagnetic signature, creating a synthetic signature composed of one or more signatures, or experimenting with novel EM field patterns. The directive can instruct the system to emit a single signature, replicate an existing EM pattern or respond to environmental stimuli.

In one instance, a synthetic object may be generated to simulate an interaction with a gardener. The data stored would have a range of EM signatures determined to be “positive interactions” that were recorded in the context of a gardener feeding their plants. The synthetic object “positive gardener” would always emit EMs recorded in feeding interactions with the plants.

In another example, an interaction between two humans which have varied signatures and varied results. In an example where the stimuli from the environment is labelled as positive such as a positive tone of voice (this is common in data labelling available with generative AI), the synthetic object will emit a recorded signature associated with positive metadata. When the stimuli is negative (such as a negative tone of voice, yelling, or a plot point in a horror movie that is scary), a secondary signal may be generated to change the EM field outputs to match the tone or meta-data of a negative interaction, which data may have been previously recorded.

In the method 300, the EM field values to be emulated are returned 310. The EM field values allow an EM signature to be generated and emitted. This is performed to retrieve that data needed to simulate or emulate the EM field or radiation. In one example, the synthesis engine may access the EM database to retrieve predefined or real-time EM field values that align with the directive. This may include raw EM values, patterns, or synthesized data for emission.

Next, the EM field is emitted 312. More specifically, outputs (EM fields) are generated into the environment or to a target. A simulator may emit the EM field based on calculated parameters. The emission may be directed at a physical space, device, or user.

Feedback may be gathered 314 or collected. The feedback may include data on the systems performance and/or user/environmental reactions to the emitted EM field. The feedback may include user reactions, environmental changes, or device responses. This data is stored in the feedback database for analysis and system refinement. The feedback may enable iterative improvement of the simulation operation. In one example, the feedback may cause a loop that allows the directive to be modified or refined.

### EXAMPLE

In one example, a user desires to generate a synthetic object that simulates a human in a work environment. The ideal coworker would do the work and would have the ‘feeling’ of camaraderie-which may include aspects of tone, visualization, and the EM field for a human that aligns with the experience.

In one example, the coworker may be designed by AI via code, via a graphical user experiences, or the like. The user assigns an object name of Alison to the synthetic coworker. Alison is assigned the following metadata:
the skills of a prompt designer. This is achieved by using the secondary source input of Generative AI (aka an OpenAI prompt which reads “You will act as a prompt engineering expert”).
An object type of “human” (this is stored as metadata and assigns the visualization to a human form if the synthetic object is visualized as an avatar)
A language type of “English” (this is stored as metadata and assigns the LLM to be an English language model)
An EM type as “human” (this is stored as metadata, and the synthetic generator will pull from the list of available Human EM models upon instantiation of the object
EM behavior as “modeled based on the tone of the conversation” (this is stored as metadata and will influence the selection of the EM model to ensure the existence of multiple emotions so the EM field can be responsive)
EM opt-in for feedback of “include” (indicates a behavior that will randomly ask the human interacting with the synthetic persona how they believe the Alison object “feels”).

In operation, an employee may request the assistance of a prompt engineer. The employee accesses the “request an AI coworker” user interface and selects a coworker type of Prompt Engineer Alison.

The synthesis engine may synthesize Alison by collating:
The GenAI LLM of English,
The voice model of human female,
The visual model of human female,
The EM from a human female with EM type of variant/responsive,
If there is more than one EM model of human type, EM models with variant values and metadata associated with emotion are returned,
If there is more than one model, EM model with highest feedback accuracy is returned
Feedback accuracy can be calculated using any form of mathematics, but one example is:
   If EM model has been deployed and feedback was included:
      When prompted, did the human feedback match the “GenAI” predicted tone/feeling.
      If yes +1
      If no −1
      If near match +0,
   Order Models by score, highest to lowest,
   Select model with highest score.

Alternatively, EM models may be segmented by the score related to a specific emotion only. In one example, EM outputs across multiple models may be synthesized.

An EM model with highest score feedback for “happy” or “Excited” would be used for interactions with ‘Happy’ or “Excited” perceived values (e.g., based on “sentiment analysis” https://www.airops.com/nlp-guide/how-to-analyze-sentiment-of-groove-support-tickets-chats-with-generative-ai).

EM model with highest score feedback for “negative” sentiment would be used to emulate EM fields during negative interactions. These may both exist within a single interaction and would be usable in tandem.

The employee starts to work on the assignment. The employee requests assistance from ‘Alison’ (via chat, text, voice or video conversation or in-person conversation with a robot which takes on the synthetic persona of Alison). If the first interaction is neutral, the hardware associated with Alison produces the EM field associated with neutral emotion.

If user gets an answer that is not aligned with their intent. The user enters or otherwise communicates (or sentiment is detected) that they are upset (e.g., angry). Alison interprets this sentiment as unhappy and the back end system dictates that the correct EM response to “user Angry” is “conciliatory/sympathetic”, Alison returns text which indicates “how can I improve” and emits an EM field value that matches the highest score feedback for “conciliatory/sympathetic”.

The user and Alison continue to interact to return the prompt. When the prompt is complete, and the user acknowledges that the interaction is successful (through words, visual inspection of the users face, or tone or other feedback mechanism), Alison interprets that the user is “happy” and the appropriate response to the sentiment is to also emulate joy or happiness. Alison emits that EM field that is associated with “Happy”.

The user is prompted to supply feedback on their perspective of Alisons'performance and projected feelings on the interaction.

This feedback is stored in the Historian and used in future score analysis.

This patent protects the system and method of collecting electromagnetic signals from secondary sources, associating the signals with stimuli and/or metadata (including keywords, environmental behaviors, or situational details), and associating both the signature and the stimuli with one or more objects in a data store. Then in real-time or near real-time or on demand, when a synthetic version of an object is recalled or created, an electromagnetic field can also be generated during the desired time (based on event, keyword, timed, or always-on) creating an effect at scale which invokes desired outcomes.

Embodiments of the invention may be used with virtual or augmented reality devices or headsets. An emission module may be coupled to these devices or integrated into these devices such that synthetic EM fields can be generated in a multi-sensory environment.

Sensors can detect changes in a user's mood, environmental conditions, and the like. These changes may be used to generate an EM field to enhance or counteract the feedback.

Further multiple objects may be simultaneously simulated by retrieving and synthesizing EM fields for each object.

In another example, farmers and gardeners often develop strong bonds with their plants. By associating a synthetic version of a person with their unique EM signature, a replica could be placed in a nursery or field to influence plant growth positively. For instance, a farmer could replicate their presence across vast fields using AI-driven holograms emitting their specific EM signature, helping the health and well-being of the plants.

A gardener could use a synthetic replica of themselves, programmed with their unique EM field, to “stand in” for them in a greenhouse. The plants may respond to the synthetic presence as if the gardener were there, potentially promoting healthier growth to EM fields that may augment the experiences of plants, animals, or humans.

In another example, synthetic replicas of living beings may be generated, such as AI-powered humanoids or robotic pets. These replicas can mimic physical appearance, voice, and behaviors. Embodiments of the invention further enhance their realism by causing the replicas to emit EM fields. For example, EM data may be recorded in advance and used in replicas.

Embodiments of the invention may also enhance remote communications. In one example, EM signatures may be associated with synthetic projections, such as holograms or telepresence robots or as an extension to an online call. This allows the sensation of being in the same room as a person to be perceived, thereby enhancing the emotional depth of remote communication.

Embodiments may enable commercial and personal applications. Celebrities could capture their EM signatures and offer them as a product, alongside perfumes or other merchandise, to create a unique sensory experience. Positive or calming EM signatures could be marketed as a means to influence the mood of a room or individual.

Synthetic objects could be designed to emit specific EM signatures for compatibility testing in fields like social matching or team dynamics. For instance, interactions between synthetic personas could predict compatibility in scenarios like matchmaking or group assembly.

In another example, spaces may be equipped with devices that generate dynamic EMF patterns in sync with synthetic stimuli. These might mimic crowd-like conditions or emotional resonance. Combining advanced sound design, haptics, and simulated EMF fields might approximate the feeling of presence.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, synthetic object generation operations, EM signature emission operations, EM signature collection operation, and the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data processing, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer.

As used herein, the term ‘data’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: generating a synthesized object, by a synthesis engine, based on input received via a user interface from a user, wherein the input values relate to the synthesized object, determining a directive for the synthesized object, determining an electromagnetic (EM) signature and providing EM data for generating the EM signature, and emitting the EM signature based on the EM data using an emitter associated with the synthesized object.

Embodiment 2. The method of embodiment 1, further comprising initializing the synthesis engine such that the synthesis engine is configured to interact with and manage an environment in which the synthesis object is deployed, wherein the synthesis engine comprises an emitter configured to emit the EM signature.

Embodiment 3. The method of embodiment 1 and/or 2, further comprising checking user permissions to ensure that the user has permissions to generate and use the synthesized object.

Embodiment 4. The method of embodiment 1, 2, and/or 3, wherein the input includes settings of variables selected by the user or by default, wherein the variables include one or more of: a voice, a gender, an age, a location, an EM action, an EM exposure, and an EM time or combinations thereof.

Embodiment 5. The method of embodiment 1, 2, 3, and/or 4, wherein the EM action is an emotional state, the EM exposure specifies an external stimuli, and the EM time determines a time during which the EM signature is emitted.

Embodiment 6. The method of embodiment 1, 2, 3, 4, and/or 5, wherein the synthesis engine comprises databases including one or more of: an EM database configured to store EM data collected from secondary sources, an object database configured to store records of objects or entities generating EM signatures and their metadata, a secondary database storing sources of data and their relationships to the EM data, a synthetic object database configured to store synthesized representations of objects based on EM and metadata inputs, a feedback database configured to capture feedback for refining the generation of synthetic objects, a user database configured to store user information, their permissions, and metadata, and a historian configured to store data and relationships for analysis and traceability.

Embodiment 7. The method of embodiment 1, 2, 3, 4, 5, and/or 6, wherein the directive comprises a task or objective of the synthesized object.

Embodiment 8. The method of embodiment 1, 2, 3, 4, 5, 6, and/or 7, further comprising returning the EM data from an EM database, wherein the EM data is aligned with the directive or based on user or environmental factors.

Embodiment 9. The method of embodiment 1, 2, 3, 4, 5, 6, 7, and/or 8, wherein the user factors include sentiment data, wherein the EM data is changed based on the user factors.

Embodiment 10. The method of embodiment 1, 2, 3, 4, 5, 6, 7, 8, and/or 9, further comprising receiving feedback incorporated into subsequent generations of synthesized objects.

Embodiment 11 A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use a computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

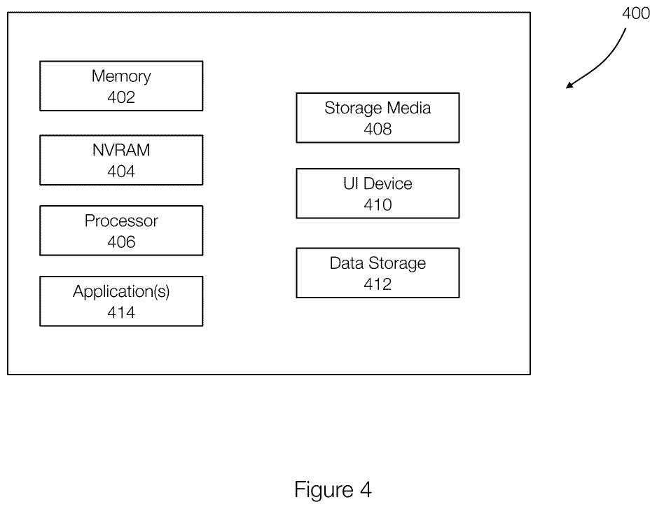

With reference to FIG. 4, one or more of the entities or systems disclosed, or implied, by the Figures and/or elsewhere herein, may take the form of, or include, or be implemented on, or hosted by, a physical computing device, one example of which is denoted at 400 in FIG. 4. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
generating a synthesized object, by a synthesis engine, based on input received via a user interface from a user, wherein the input values relate to the synthesized object;
determining a directive for the synthesized object;
determining an electromagnetic (EM) signature and providing EM data for generating the EM signature; and
emitting the EM signature based on the EM data using an emitter associated with the synthesized object.

2. The method of claim 1, further comprising initializing the synthesis engine such that the synthesis engine is configured to interact with and manage an environment in which the synthesis object is deployed, wherein the synthesis engine comprises an emitter configured to emit the EM signature.

3. The method of claim 1, further comprising checking user permissions to ensure that the user has permissions to generate and use the synthesized object.

4. The method of claim 1, wherein the input includes settings of variables selected by the user or by default, wherein the variables include one or more of: a voice, a gender, an age, a location, an EM action, an EM exposure, and an EM time or combinations thereof.

5. The method of claim 4, wherein the EM action is an emotional state, the EM exposure specifies an external stimuli, and the EM time determines a time during which the EM signature is emitted.

6. The method of claim 1, wherein the synthesis engine comprises databases including one or more of:
an EM database configured to store EM data collected from secondary sources,
an object database configured to store records of objects or entities generating EM signatures and their metadata;
a secondary database storing sources of data and their relationships to the EM data;
a synthetic object database configured to store synthesized representations of objects based on EM and metadata inputs;
a feedback database configured to capture feedback for refining the generation of synthetic objects;
a user database configured to store user information, their permissions, and metadata; and
a historian configured to store data and relationships for analysis and traceability.

7. The method of claim 1, wherein the directive comprises a task or objective of the synthesized object.

8. The method of claim 7, further comprising returning the EM data from an EM database, wherein the EM data is aligned with the directive or based on user or environmental factors.

9. The method of claim 8, wherein the user factors include sentiment data, wherein the EM data is changed based on the user factors.

10. The method of claim 1, further comprising receiving feedback incorporated into subsequent generations of synthesized objects.

11. A non-transitory storage medium having stored therein instructions that are executable by one or more hardware processors to perform operations comprising:
a generating a synthesized object, by a synthesis engine, based on input received via a user interface from a user, wherein the input values relate to the synthesized object;
determining a directive for the synthesized object;
determining an electromagnetic (EM) signature and providing EM data for generating the EM signature; and
emitting the EM signature based on the EM data using an emitter associated with the synthesized object.

12. The non-transitory storage medium of claim 11, further comprising initializing the synthesis engine such that the synthesis engine is configured to interact with and manage an environment in which the synthesis object is deployed, wherein the synthesis engine comprises an emitter configured to emit the EM signature.

13. The non-transitory storage medium of claim 11, further comprising checking user permissions to ensure that the user has permissions to generate and use the synthesized object.

14. The non-transitory storage medium of claim 11, wherein the input includes settings of variables selected by the user or by default, wherein the variables include one or more of: a voice, a gender, an age, a location, an EM action, an EM exposure, and an EM time or combinations thereof.

15. The non-transitory storage medium of claim 14, wherein the EM action is an emotional state, the EM exposure specifies an external stimuli, and the EM time determines a time during which the EM signature is emitted.

16. The non-transitory storage medium of claim 11, wherein the synthesis engine comprises databases including one or more of:
an EM database configured to store EM data collected from secondary sources,
an object database configured to store records of objects or entities generating EM signatures and their metadata;
a secondary database storing sources of data and their relationships to the EM data;
a synthetic object database configured to store synthesized representations of objects based on EM and metadata inputs;
a feedback database configured to capture feedback for refining the generation of synthetic objects;
a user database configured to store user information, their permissions, and metadata; and
a historian configured to store data and relationships for analysis and traceability.

17. The non-transitory storage medium of claim 11, wherein the directive comprises a task or objective of the synthesized object.

18. The non-transitory storage medium of claim 17, further comprising returning the EM data from an EM database, wherein the EM data is aligned with the directive or based on user or environmental factors.

19. The non-transitory storage medium of claim 18, wherein the user factors include sentiment data, wherein the EM data is changed based on the user factors.

20. The non-transitory storage medium of claim 11, further comprising receiving feedback incorporated into subsequent generations of synthesized objects.
